(19) United States
(12) Patent Application Publication
(10) Pub. No.: US 2006/0194601 A1
(43) Pub. Date: Aug. 31, 2006

(54) Admission control to wireless network based on guaranteed transmission rate

(75) Inventor: Sai Shankar Nandagopalan, Tarrytown, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V.

(21) Appl. No.: 10/565,665

(22) PCT Filed: Jul. 20, 2004
(86) PCT No.: PCT/IB04/51266

§ 371 Date: Jan. 23, 2006

Related U.S. Application Data
(60) Provisional application No. 60/489,686, filed on Jul. 24, 2003.
(60) Provisional application No. 60/543,704, filed on Feb. 11, 2004.

(51) Int. Cl. H04B 17/00; H04B 7/00

(52) U.S. Cl. 455/515; 455/67.11

(57) ABSTRACT

Admission control for parameterized traffic among wireless stations and an access point takes into account time varying channel capacity as well as loss characteristics of the wireless channel in guaranteeing specified quality-of-service (QoS). In addition, transmission burstiness, which is a difference between a minimum transmission rate specified by the station and a current transmission rate, is used to increase the bandwidth guaranteed at admission. Both size overhead, as from packet headers, and time overhead, as from polling, is taken into account in an admission process that converts a guaranteed transmission rate into air time units. Efficient admission control is accomplished using a minimal subset of the standard parameters specified by the wireless station.

The present invention is directed to networks having wireless stations and a controller. More particularly, the present invention is pertains to admission control in wireless networks based on a guaranteed transmission rate.

Quality-of-service (QoS), which affords the user a level of service according to a priority the user designates, and multimedia support are critical to wireless home networks where voice, video and audio will be delivered across multiple networked home electronic devices. Broadband service providers view QoS- and multimedia-capable home networks as an essential ingredient to offering residential customers video on demand, audio on demand, voice of IP (Internet Protocol) and high-speed Internet access. QoS is also a critical element for consumer electronic companies looking to offer home wireless networking devices. Currently, the IEEE 802.11e protocol is being considered by the consumer electronic as well as the data communication companies as “the” solution to offer QoS. The IEEE 802.11e draft version 3.3 (802.11e/D3.3), approved in September 2002, forms the core of what will eventually become an approved standard in the future. The draft provides protocol for QoS support but not the algorithms that are required along with the protocol to guarantee QoS. Support for implementation of IEEE 802.11e to satisfy diverse requirements of diverse markets requires, in addition to a good scheduling algorithm, an efficient admission control algorithm which decides whether to admit traffic streams based on the scheduling algorithm.

FIG. 1 depicts a conventional wireless local area network (LAN) 100 operating under IEEE 802.11e. LAN 100 includes an access point (AP) or QoS AP (QAP) 104 and wireless stations (WSTAs) 108-1 to 108-N in wireless communicative connection by means of the wireless medium or channel 112. WSTAs within LAN 100 that make QoS requirements (QSTAs) may operate along with WSTAs for which best-effort support is provided. That is, resources are afforded as they become available, with no guarantee or reservation of those resources. As shown in FIG. 1, referring to traffic streams 116-1 to 116-N, the QAP 104 can communicate downstream with each of the WSTAs 108-1 to 108-N, and each of the WSTAs can communicate upstream with the QAP. Additionally, WSTAs may communicate with each other sidestream, as by the traffic stream 120.

IEEE 802.11e provides two methods for accessing the WM 112. One of the methods is contention-based, so that WSTAs 108-1 to 108-N attempting to transmit on the WM 112 compete for access. The other method is polling-based and features the periodic polling by the AP 104 of each WSTA 108-1 to 108-N in order to afford it access for a pre-set time interval. The two methods are known as prioritized and parameterized QoS access, respectively. The present invention concerns admission control for parameterized traffic.

Admission control under IEEE 802.11e operates according to parameters in the traffic specification (TSPEC) element which represent the QoS that the WSTA designates for its communication on the WM 112 with the QAP 104 or with another WSTA. If an admission control unit (ACU) (not shown) at the QAP 104 determines, based on the parameters, that the network has the bandwidth resources to accommodate, while maintaining existing connections according to QoS dictates, a new traffic stream (TS) for the requesting WSTA, the ACU will admit the TS. Otherwise, admission is denied.

Once a TS is admitted, IEEE 802.11e provides for supervision of the TS to ensure that the TS continues to meet the QoS parameters within the TSPEC element based upon which it was granted admission. If parameters are exceeded, ACU may drop frames of the TS or mark them with lower QoS priority depending on the demands of current conditions on the channel 112.

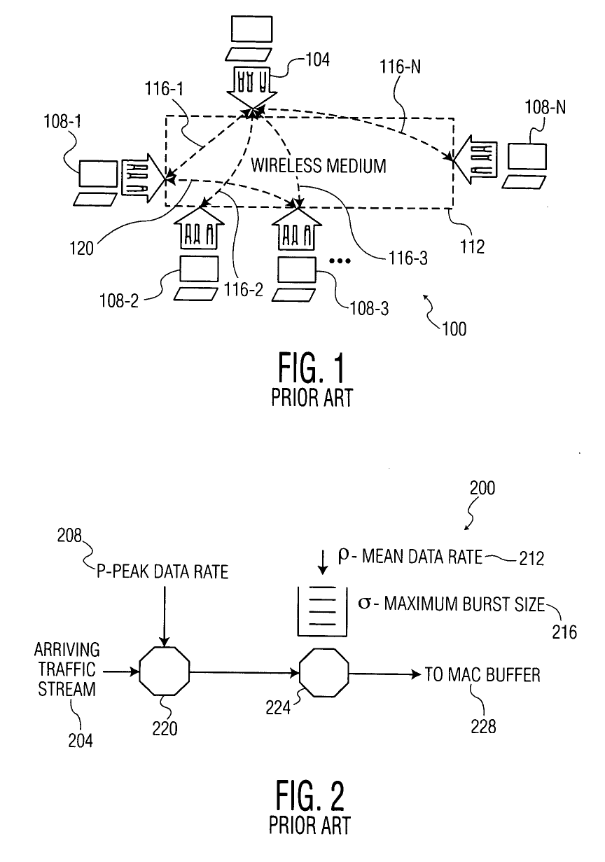

A dual bucket policer 200 shown in FIG. 2 regulates the transmission of each admitted TS 204 in accordance with three of its TSPEC parameters: peak data rate P 208, mean data rate ρ 212 and maximum burst size σ 216. The policer 200 is located at the entrance of the medium access layer (MAC) to receive the TS 204 from an upper layer.

The first bucket 220 limits a maximum transmission rate of the TS 204 to the peak transmission rate 208. This is accomplished by means of tokens which arrive at the first bucket 220 at rate r. If P and r are in the same units of data length, which can arbitrarily be termed a “byte,” and in the same units of time, each token permits passage of P/r bytes of TS 204. If a byte of the TS 204 arrives at the first bucket 220 at a time other than when a token arrives at the first bucket, the byte waits at the first bucket. As a token arrives at the first bucket 220, if a byte of the TS 204 is waiting at the first bucket, the token allows passage by that byte through to the second bucket 224, and the token is spent. Otherwise, if a byte is not present at the time the token arrives at the first bucket 220, the token is discarded. Since the first bucket 220 has no buffering to retain unused tokens, the first bucket is said to have a “bucket depth” of zero. As a consequence of the above, the TS 204 leaves the first bucket 220 for the second bucket 224 at no more than the peak transmission rate P.

The second bucket 224 has a depth of σ which is the maximum burst size. This means that up to σ tokens can be retained in the second bucket 224. If the bucket is full, arriving tokens are discarded. A “burst” is, within “zero” time, an instantaneous flow of traffic here limited to a maximum size of σ. Tokens arrive at the second bucket at rate s. If ρ and s are in the same units of data length, which can arbitrarily be termed a “byte,” and in the same units of time, each token permits passage of ρ/s bytes of TS 204. If a byte of the TS 204 arrives at the second bucket 224 at a time when no token is waiting at the second bucket, the byte waits at the second bucket. As a token arrives at the second bucket 224, if a byte of the TS 204 is waiting at the second bucket, the token allows passage by that byte through to the MAC buffer 228, the token thereby being spent. Otherwise, if a byte is not waiting at the time the token arrives at the second bucket 224, the token is retained in the second bucket, if the second bucket is not already full. Accordingly, within any time period t having the same time units as ρ, the maximum TS 204 output rate of the second bucket 224 is σ+ρt. The maximum cumulative number of arrivals through the policer 200 to the MAC buffer 228 in any time period (t, t+τ) is therefore:
A(t, t+τ)=Min(Pτ, σ+ρτ)

If the ACU were to admit a TS 204 only when its peak data rate P and the peak data rates of all traffic streams already admitted can unfailingly be accommodated, a relatively small number of streams would be admitted and much bandwidth would be wasted. On the other hand, basing admission of TS 204 purely on the mean data rate ρ and the mean data rates of the already-admitted traffic streams, while it allows many streams to be admitted, risks the loss of data when streams transmit at their peak data rates. Accordingly, by the principles of statistical multiplexing that not all streams will transmit at their peak rates concurrently, admission criteria must be based on some statistic between the mean and peak rates.

Providing QoS guarantees in wireless LANs is an inherently challenging task. The time varying nature of the channel and mobility of users imposes additional constraints in guaranteeing the QoS requirements of the application as compared to their wired counterparts. Significantly, the mobility of the user introduces location-dependent errors.

Many of the admission control schemes today do not take into consideration the time varying nature of the channel or the location-dependent errors and do not consider multi-rate transmission which is very common in IEEE 802.11e. Efficient admission control is needed to meet these challenges.

The present invention has been made to address the above -noted shortcomings in the prior art. It is an object of the invention to provide efficient admission control for a wireless LAN that takes into account the time varying nature o f the channel, location-dependent errors and multi-rate transmission.

In brief, admission control for a wireless network that includes a wireless stations and a controller involves calculating a guaranteed transmission rate for a station. This is calculated based upon a maximum buffer size. The latter is equal to the product of a delay and an amount by which a peak transmission rate of the station exceeds the guaranteed rate. The delay is inversely proportional to a difference between the peak transmission rate and the mean transmission rate of the station. The admission control further involves determining, based on the calculated guaranteed transmission rate, whether the station is granted a right to communicate on a channel of the network.

Details of the invention disclosed herein shall be described with the aid of the figures listed below, wherein:

FIG. 1 is a flow diagram depicting a conventional wireless LAN;

FIG. 2 is a conceptual diagram showing a dual bucket policer for maintaining QoS;

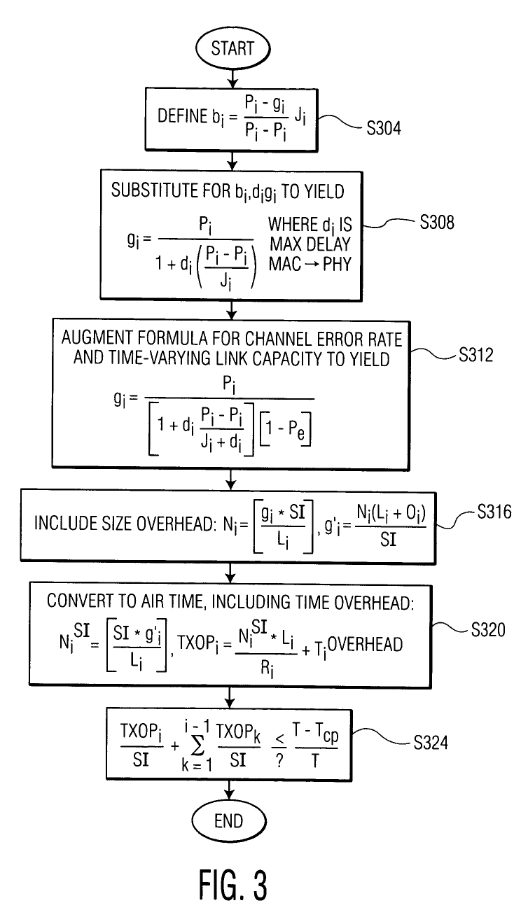

FIG. 3 is a flow chart illustrating an example of a process of deriving an admission control algorithm in accordance with the present invention; and

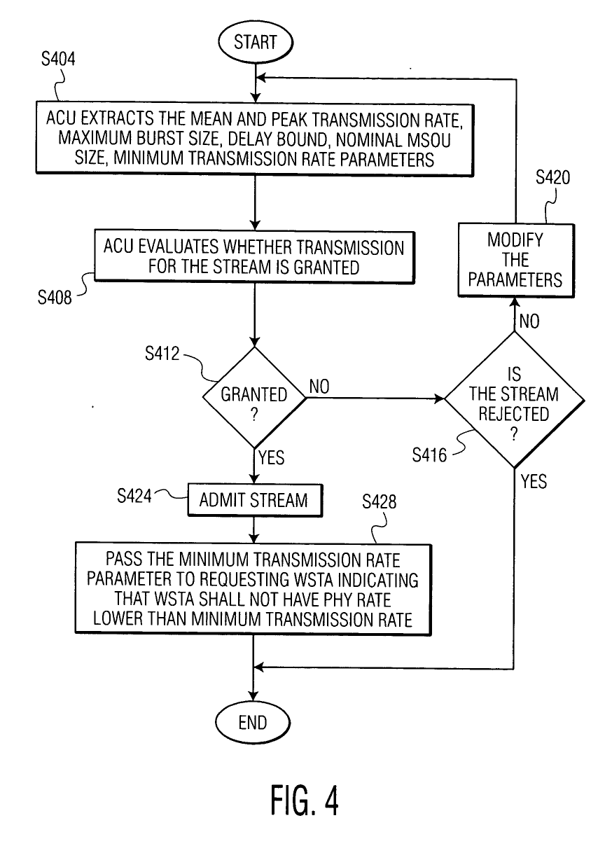

FIG. 4 is a flow chart illustrating an example of admission control in accordance with the present invention.

FIG. 3 shows, by way of illustrative and non-limitative example, derivation of an efficient admission control algorithm in accordance with the present invention. Traffic passing through the respective dual token bucket 220 and received in the respective MAC buffer 228 of a WSTA 108-1 to 108-N or the MAC buffer 228 of the QAP 104, will have to be serviced by at least a particular respective rate to keep the buffer from overflowing. This is called hereinafter the “guaranteed rate.” Since the packets by which data is transported in IEEE 802.11e are typically navigated by dynamically-changing paths, “guarantee” is in this sense a soft guarantee that amounts to a “best effort” by default and to targeted levels of performance at the various QoS user priority levels.

Yet, the rate must be low enough so as not to overwhelm the bandwidth of the wireless medium 112.

The maximum size needed for the MAC buffer 228 of TS 204 is given by the formula:
bᵢ=σᵢ(Pᵢ−gᵢ)/(Pᵢ−ρᵢ) (equation 1)
where the index i represents parameters that apply to TS 204 at a particular WSTA or at the QAP.

In determining the maximum buffer size bᵢ, the worst-case scenario is considered in terms of delay. That is, the second bucket 224 is full, and the TS 204 passes through the first bucket 220 at peak rate Pᵢ. In this case, the traffic passing through will continue on to, likewise, pass through the second bucket 224 at peak rate Pᵢ as long as unspent tokens remain in the second bucket. This traffic passing through the second bucket 224 will arrive at the MAC buffer 228. Concurrent with the filling of the buffer 228 at peak rate Pᵢ, the buffer is being emptied at a rate greater or equal to the guaranteed or minimally sufficient buffer-emptying rate gᵢ. Again, for worst-case scenario purposes, the guaranteed rate is assumed to be equal to gᵢ. The queuing within buffer 228 is therefore increasing at the rate Pᵢ−gᵢ during the time period in which the second bucket 224 is being emptied of tokens. Once the tokens are spent, traffic passes through to the MAC buffer 228 at a maximum rate of ρᵢ. Since, however, the guaranteed rate gᵢ exceeds ρ, buildup of traffic in the buffer 228 ceases once the tokens are spent.

Having determined the rate of this buildup in buffer 228, Pᵢ−gᵢ, it remains to be determined over what time period the buildup occurs in order to calculate the maximum buffer size bᵢ. Notably, in this regard, while the tokens are being spent, the second bucket 224 continues to be replenished at the rate of ρᵢ, even while the tokens are being spent at the rate Pᵢ. The net rate of token depletion is thus Pᵢ−ρᵢ. Moreover, the total number of tokens to be depleted is equal to the depth of the second bucket 224, namely σ. Therefore, the time period during which the tokens in the second bucket 224 are depleted or spent is σᵢ/(Pᵢ−ρᵢ). This is the same time period, however, during which traffic builds up in the MAC buffer 228, at the rate Pᵢ−gᵢ as discussed above. This time period represents a delay for the traffic in the MAC buffer 228. The maximum buffer size bᵢ is therefore equal to the buildup rate time the buildup period, or (Pᵢ−gᵢ)(σᵢ/(Pᵢ−ρᵢ)) which is reflected in equation 1 above (FIG. 3, step S304).

One of the parameters in the TSPEC is the delay bound dᵢ, which specifies the maximum amount of time to transport a MAC service data unit (MSDU) belonging to the TS, measured between the time marking the arrival of the MSDU at the local MAC sublayer and the time starting the successful transmission or retransmission of the MSDU to the destination WSTA or QAP. The MSDU is a frame of the TS 204. In other words, the delay dᵢ is the maximum delay between arrival of a data frame at the MAC layer and the start of transmission of the frame on the physical (PHY) layer.

The rate gᵢ at which the MAC buffer of maximum size bᵢ is serviced must be greater or equal to bᵢ/dᵢ. As shown in step S308, substituting this equality into equation 1 yields:
gᵢ=Pᵢ/[1+dᵢ(Pᵢ−ρᵢ)/σᵢ] (equation 2)

Errors, which arise due to interference and which are often location-dependent, must be taken into account, because unsuccessful attempts to transmit may give rise to attempts to re-transmit

In addition, the rate at which a WSTA 108-1 to 108-N communicates with a destination is often varies dependent on its distance from the destination. Another reason transmission rates can vary is due to the mobility of the WSTAs. Accordingly, the bandwidth or capacity of the channel 112 available to a WSTA 108-1 to 108-N or to the QAP may vary. If the bandwidth rises, this is not a problem. The problem arises if the bandwidth drops and the wireless channel 112 is nearly full. To account for this, the guaranteed rate gᵢ needs to be provided with extra resilience. The concept of transmission burstiness δ is introduced to implement the needed resilience. The transmission burstiness δ represents an amount of drop in channel capacity. If C is the portion of the original channel capacity available to a TS, the maximum number of bits that can be on the WM 112 during any time period t is C×t. Due to interference and mobility, the channel capacity may drop by a factor δ, so that in the time period t<dᵢ, the lower bound on the channel capacity available to the TS is (C×t)−δᵢ. To compensate for the possible bandwidth drop, the guaranteed rate gᵢ is increased such that it could accommodate a corresponding deepening of the second token bucket 224 by δᵢ. That is, deepening the second token bucket 224 by δᵢ prolongs the filling of the MAC buffer 228 at peak data rate P, thereby increasing by δᵢ the queuing in the MAC buffer. Accordingly, an increased gᵢ is needed to compensate for the degradation in gᵢ that might result from the bandwidth drop. Transmission burstiness δ can be obtained as the difference between the observed physical layer (PHY) transmission rate, i.e., the rate of transmission between WSTAs or a WSTA and the QAP, at which the TS 204 is transmitting and a minimum transmission rate that the WSTA has specified as a TSPEC parameter. As show n in step S312, the formula for gᵢ augmented to account for channel error rate and time varying link capacity is:
gᵢ=Pᵢ/([1+dᵢ(Pᵢ−ρᵢ)/(σᵢ+δᵢ)][1−pₑ]) (equation 3)
where pₑ is the probability of error in a frame which can be estimated from the past history of the link condition to this WSTA or QAP or can be determined based on admission control requests emanating from the WSTA.

The above analysis ignores size overhead, since the mean and peak transmission rates ρ, P do not account for the transmission of data headers. Layers above the MAC each attach their respective headers to the payload data, and the MAC layer attache s its own header before transmitting the traffic on the underlying PHY layer. Another TSPEC parameter is nominal MSDU size Lᵢ which does not account for headers. The QAP 104 polls the WSTAs 108-1 to 108-N successively and accords to each WSTA its respective service interval SI during which the WSTA receives a transmission opportunity TXOP of specified time length. During the TXOP, the WSTA can transmit one or more MSDUs each of size Lᵢ. The number of MSDUs is given by:
Nᵢ=┌(gᵢ*SI)/Lᵢ┐ (equation 4)
where “┌ ┐” signifies “the greatest integer not greater than”

In step S316, the guaranteed rate is accordingly modified as:
gᵢ′=Nᵢ(Lᵢ+Oᵢ)/SI (equation 5)
where Oᵢ represents the size overhead

For each MSDU frame there is an overhead in time based on the acknowledgment (ACK) policy, interframe spacing (IFS) time, PLCPreamble, MAC and PHY layer headers and the polling overhead for upstream and sidestream transmission. The scheduling policy also determines the polling overheads as different scheduling policies determine how many times one needs to poll a WSTA per SI. To account for time overhead (step S320), the number of MSDUs per service interval is recalculated:
Nᵢ^{SI}=┌SI*gᵢ′/Lᵢ┐ (equation 6)

Then the ACU calculates the TXOP that is required to service all of these MSDUs in a service interval. This is given by:
TXOPᵢ=Nᵢ^{SI}*Lᵢ/Rᵢ+Tᵢ^{overhead} (equation 7)
where Tᵢ^{overhead} is the time overhead, and Rᵢ≧gᵢ′ is the TSPEC parameter specifying the minimum PHY transmission rate

By virtue of equations 6 and 7, the guaranteed transmission rate for a traffic stream has been converted to air time, i.e. transmission time.

Finally, in step S324, the admission control algorithm is:
TXOPᵢ/SI+ΣTXOPₖ/SI≦(T−T_{CP})/T (equation 8)
over all traffic streams k from 1 to i−1,
where T is the beacon interval and T_{CP} is the time reserved for EDCF, i.e. non-polled, traffic.

FIG. 4 illustrates an exemplary admission control process in accordance with the present invention. This process is executable at the QAP 104 as by software in a computer-readable medium on a general-purpose computer, or by means of a dedicated processor, and may alternatively be embodied in hardware or firmware.

Advantageously and has been demonstrated above, the ACU at the QAP 104 needs only extract from the TSPEC received from the WSTA 108-1 to 108-N a minimal subset of TSPEC parameters, namely the mean and peak transmission rates, the maximum burst size, the delay bound, the nominal MSDU size and the minimum transmission rate (step S404). Using the equations set forth above, the ACU then determines whether the traffic stream seeking admission is to be granted the admission. Specifically, if the inequality in equation 8 above is satisfied, the stream is granted admission; otherwise, admission is denied (step S408). If admission is denied (step S412), and the stream is not rejected (step S416), the subset of parameters is modified, as by the QAP 104 or the WSTA 108-1 to 108-N (step S420), and the modified parameters are submitted for reconsideration by the ACU. If and when admission is granted (step S424), the minimum transmission rate parameter, which is subject to negotiation between the QAP 104 and a WSTA 108-1 to 108-N, is communicated to the WSTA (step S428), thereby indicating to the WSTA that it shall enjoy a PHY transmission rate not lower than the minimum transmission rate determined.

While there have been shown and described what are considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An admission control method for a wireless network (100) that includes a plurality of wireless stations (108-1-108-n) and a controller (104), comprising the steps of:
calculating, for a station of the plurality, a minimally sufficient buffer-emptying rate (S308) based upon a maximum buffer size (S304) which is equal to the product of a delay and an amount by which a peak transmission rate (208) of said station exceeds the calculated rate, said delay being inversely proportional to a difference between said peak transmission rate and a mean transmission rate (212) of said station; and
determining, based on the calculated rate, whether said station of the plurality is granted a right to communicate on a channel of the network (112, S412).

2. The method of claim 1, wherein the buffer size is bounded by the product of the calculated rate for said station and a maximum delay between arrival of a data frame at a medium access control (MAC) layer and a beginning of transmission of the frame on a physical (PHY) layer (S308).

3. The method of claim 1, wherein the calculated rate of said station is inversely proportional to one minus a determined probability of error for transmitting a frame on the channel (S312).

4. The method of claim 1, wherein said delay is based upon a maximum burst size (216) representative of a bucket depth of a second token bucket (224) of a dual token bucket policer (200) at the controller, the first bucket having zero depth, tokens arriving at the first and second buckets at respective rates allowing respective passage of the arriving traffic at said peak and mean transmission rates, respectively.

5. The method of claim 1, wherein said delay is based upon a magnitude of a drop of a bandwidth of the channel to a predetermined amount that would serve as a basis for revoking said right (S312).

6. The method of claim 5, wherein said delay is based upon a maximum burst size (216) representative of a bucket depth of a second token bucket (224) of a dual token bucket policer (200) at the controller (104), the first bucket having zero depth, tokens arriving at the first and second buckets at respective rates allowing respective passage of the arriving traffic at said peak and mean transmission rates, respectively.

7. The method of claim 1, wherein said right to communicate allows said station to transmit at least one frame during a transmission opportunity time interval, said calculating determining, for the purpose of adding size overhead to said at least one frame, how many of the frames fit within said interval (S316).

8. The method of claim 1, the determining step further comprises the steps of calculating respective minimally sufficient buffer-emptying rates of the plural stations, converting said respective minimally sufficient buffer-emptying rates to respective air times (S320), and summing the air times for comparison with an air time threshold of the channel (S324).

9. The method of claim 8, wherein the calculating step further comprises the step of receiving as parameters transmitted from said station, to execute the calculating and determining steps, only the mean transmission rate, the peak transmission rate, a maximum burst size, a maximum delay, a data frame size and a minimum transmission rate (S404).

10. A network having admission control, the network comprising:
a plurality of wireless stations (108-1-108-N);
a controller of the stations (104);
a communication channel (112) for wirelessly connecting the plural stations and the controller; and
a buffer (228) for receiving at least one of upstream traffic to the controller, downstream traffic from the controller (116-1-116-3) and station-to-station sidestream traffic (120), said controller being configured for calculating a minimally sufficient rate (S308) of emptying the buffer based upon a maximum size (S304) of the buffer which is equal to the product of a delay and an amount by which a peak transmission rate (208) exceeds the calculated rate, said delay being inversely proportional to a difference between said peak transmission rate and a mean transmission rate (212) to the buffer (228), said controller being further configured for determining, based on the calculated rate, whether a station of the plurality is granted a right to communicate on said channel (112, S412).

11. The network of claim 10, wherein said maximum size is bounded by the product of the calculated rate and a maximum delay between arrival of a data frame at a medium access control (MAC) layer and a beginning of transmission of the frame on a physical (PHY) layer (S308).

12. The network of claim 10, wherein the calculated rate is inversely proportional to one minus a determined probability of error for transmitting a frame on the channel (S312).

13. The network of claim 10, wherein said delay is based upon a maximum burst size (216) representative of a bucket depth of a second token bucket (224) of a dual token bucket policer (200) at the controller, the first bucket having zero depth, tokens arriving at the first and second buckets at respective rates allowing respective passage of the arriving traffic at said peak and mean transmission rates, respectively.

14. The network of claim 10, wherein said delay is based upon a magnitude of a drop of a bandwidth of the channel to a predetermined amount that would serve as a basis for revoking said right (S312).

15. The network of claim 14, wherein said delay is based upon a maximum burst size (216) representative of a bucket depth of a second token bucket (224) of a dual token bucket policer (200) at the controller, the first bucket having zero depth, tokens arriving at the first and second buckets at respective rates allowing respective passage of the arriving traffic at said peak and mean transmission rates, respectively.

16. The network of claim 10, wherein said right to communicate allows said station to transmit at least one frame during a transmission opportunity time interval, said calculating determining, for the purpose of adding size overhead to said at least one frame, how many of the frames fit within said interval (S316).

17. The network of claim 10, wherein the determining involves calculating respective minimally sufficient buffer-emptying rates of the plural stations, converting said respective minimally sufficient buffer-emptying rates to respective air times (S320), and summing the air times for comparison with an air time threshold of the channel (S324).

18. The network of claim 17, wherein the calculating entails receiving as parameters transmitted from said station, to execute the said calculating and determining, only the mean transmission rate, the peak transmission rate, a maximum burst size, a maximum delay, a data frame size and a minimum transmission rate (S404).

19. An admission control program, embodied in a computer-readable medium, for a wireless network (100) that includes a plurality of wireless stations (108-1-108-N) and a controller (104), said program comprising instructions for:
calculating, for a station of the plurality, a minimally sufficient buffer-emptying rate (S308) based upon a maximum buffer size (S304) which is equal to the product of a delay and an amount by which a peak transmission rate (208) of said station exceeds the calculated rate, said delay being inversely proportional to a difference between said peak transmission rate and a mean transmission rate (212) of said station; and
determining, based on the calculated rate, whether said station of the plurality is granted a right to communicate on a channel of the network (S412).

20. The program of claim 1, wherein said delay is based upon a magnitude of a drop of a bandwidth of the channel to a predetermined amount that would serve as a basis for revoking said right (S312).

21. A controller for a network having admission control, the network comprising a plurality of wireless stations, the controller, a communication channel for wirelessly connecting the plural stations and the controller, and a buffer for receiving at least one of upstream traffic to the controller, downstream traffic from the controller and station-to-station sidestream traffic, said controller being configured for calculating a minimally sufficient rate of emptying the buffer based upon a maximum size of the buffer which is equal to the product of a delay and an amount by which a peak transmission rate exceeds the calculated rate, said delay being inversely proportional to a difference between said peak transmission rate and a mean transmission rate to the buffer, said controller being further configured for determining, based on the calculated rate, whether a station of the plurality is granted a right to communicate on said channel.

22. The controller of claim 21, wherein said maximum size is bounded by the product of the calculated rate and a maximum delay between arrival of a data frame at a medium access control (MAC) layer and a beginning of transmission of the frame on a physical (PHY) layer.

23. The controller of claim 21, wherein the calculated rate is inversely proportional to one minus a determined probability of error for transmitting a frame on the channel.

24. The controller of claim 23, wherein said delay is based upon a maximum burst size representative of a bucket depth of a second token bucket of a dual token bucket policer at the controller, the first bucket having zero depth, tokens arriving at the first and second buckets at respective rates allowing respective passage of the arriving traffic at said peak and mean transmission rates, respectively.

25. The controller of claim 21, wherein said delay is based upon a magnitude of a drop of a bandwidth of the channel to a predetermined amount that would serve as a basis for revoking said right.

26. The controller of claim 21, wherein said delay is based upon a maximum burst size representative of a bucket depth of a second token bucket of a dual token bucket policer at the controller, the first bucket having zero depth, tokens arriving at the first and second buckets at respective rates allowing respective passage of the arriving traffic at said peak and mean transmission rates, respectively.

27. The controller of claim 21, wherein said right to communicate allows said station to transmit at least one frame during a transmission opportunity time interval, said calculating determining, for the purpose of adding size overhead to said at least one frame, how many of the frames fit within said interval.

28. The controller of claim 21, wherein the determining involves calculating respective minimally sufficient buffer-emptying rates of the plural stations, converting said respective minimally sufficient buffer-emptying rates to respective air times, and summing the air times for comparison with an air time threshold of the channel.

29. The controller of claim 28, wherein the calculating entails receiving as parameters transmitted from said station, to execute the said calculating and determining, only the mean transmission rate, the peak transmission rate, a maximum burst size, a maximum delay, a data frame size and a minimum transmission rate.
